(19) United States
(12) Patent Application Publication
(10) Pub. No.: US 2025/0214069 A1
(43) Pub. Date: Jul. 3, 2025

(54) Supported Hydrotreating Catalysts Having Enhanced Activity

(71) Applicant: Ketjen Netherlands B.V., Amsterdam (NL)

(72) Inventors: Tjøstil Vlaar, Amsterdam (NL); Bastiaan Maarten Vogelaar, Hoofddorp (NL); Viktoria Andreevna Renkema-Krysina, Amsterdam (NL); Wilhelmus Clemens Jozef Veerman, Volendam (NL); Sona Eijsbouts-Spickova, Nieuwkuijk (NL)

(21) Appl. No.: 18/706,580

(22) PCT Filed: Nov. 4, 2022
(86) PCT No.: PCT/EP2022/080805

§ 371 Date: May 1, 2024

Related U.S. Application Data
(60) Provisional application No. 63/276,194, filed on Nov. 5, 2021.

(51) Int. Cl. B01J 31/16; B01J 21/04; B01J 35/40; B01J 37/02; B01J 37/04; B01J 37/20

(52) U.S. Cl. CPC B01J 31/165; B01J 21/04; B01J 35/40; B01J 37/0203; B01J 37/0207; B01J 37/04; B01J 37/20; B01J 2231/641; B01J 2531/64; B01J 2531/845

(57) ABSTRACT

This invention provides supported catalysts comprising a carrier, at least one Group VI metal, at least one Group VIII metal, and a polymer. In the supported catalyst, the molar ratio of the Group VI metal to the Group VIII metal is about 1:1 to about 5:1, and the polymer has a carbon backbone and comprises functional groups having at least one heteroatom. Also provided are a process for preparing such supported catalysts, as well as methods for hydrotreating, hydrodenitrogenation, and/or hydrodesulfurization, using supported catalysts.

### TECHNICAL FIELD

This invention relates to supported catalysts formed from concentrated solutions comprising a Group VI metal and a Group VIII metal.

### BACKGROUND

A variety of catalysts for hydrotreating, hydrodesulfurization, and/or hydrodenitrogenation are known and/or are commercially available. Many of these catalysts, some of which contain molybdenum, nickel or cobalt, and phosphorus, are supported on carriers, and are usually prepared by pore volume impregnation. The art continually strives to make different and better catalysts, especially with higher activities for hydrotreating, hydrodesulfurization, and/or hydrodenitrogenation.

Hydroprocessing catalysts are typically prepared by impregnation of a porous carrier material with a solution containing active metals, followed by either drying or calcination. Calcined catalysts tend to exhibit a strong metal-support interaction, which results in a high metal dispersion. However, it is theorized that strong metal-support interaction in calcined catalysts results in a lower intrinsic activity of the catalyst. Non-calcined catalysts typically show a low metal-support interaction and an intrinsically high activity. Due to the low metal-support interaction in non-calcined catalysts, the metals tend to aggregate (poor metal dispersion).

### SUMMARY OF THE INVENTION

This invention provides processes for preparing supported catalysts from concentrated solutions comprising a Group VI metal and a Group VIII metal, and catalysts prepared by such processes. Catalysts prepared according to the invention exhibit high activity in hydrodesulfurization and hydrodenitrification. It has been suggested that in the catalysts of the invention, which are polymer-modified, the hydrogenation metals are more dispersed than in similar catalysts in absence of polymer modification. A feature of this invention is that the catalysts do not contain phosphorus as an impregnated additive. Another feature of this invention is a peroxomolybdocobaltate compound that can be used when forming phosphorus-free catalysts of the invention. Increased catalytic activity is observed for catalysts according to the present invention, which catalysts are polymer-containing, as compared to similar phosphorus-free catalysts that do not contain polymers.

Chelating polymers can be synthesized in the pore structure of a carrier material (e.g. an inorganic oxide) in the presence of metals (e.g. Co, Ni, Mo). The presence of these chelating polymers enhances the activity of hydroprocessing catalysts compared to catalysts that do not contain polymers. Both the hydrodesulfurization and the hydrodenitrogenation activities are increased relative to catalysts that do not contain polymers, which makes catalysts of the invention useful in various hydrotreating applications including, but not limited to, hydrocarbon cracking pretreatment (HC-PT), fluid catalytic cracking pretreatment (FCC-PT), and ultra-low sulfur diesel (ULSD).

An embodiment of this invention is a supported catalyst. The supported catalyst comprises a carrier, at least one Group VI metal, at least one Group VIII metal, and a polymer. In the catalyst, the molar ratio of the Group VI metal to the Group VIII metal is about 1:1 to about 5:1. The polymer in the catalyst has a carbon backbone and comprises functional groups having at least one heteroatom.

Another embodiment of this invention is a peroxomolybdocobaltate compound which contains cobalt and molybdenum in a cobalt:molybdenum ratio of about 0.5:2 to about 1.5:2.

Other embodiments of this invention include processes for forming the just-described supported catalysts and the just-described peroxomolybdocobaltate compounds, as well as methods for hydrotreating, hydrodenitrogenation, and/or hydrodesulfurization, using the just-described supported catalysts.

These and other embodiments and features of this invention will be still further apparent from the ensuing description, drawings, and appended claims.

### BRIEF DESCRIPTION OF THE DRAWINGS

FIG. 1 shows FT-IR spectra providing evidence of polymerization in a sample prepared in Example 4.

FIGS. 2-1 to 2-3 show SEM-EDX linescans of samples prepared as in Example 6.

### FURTHER DETAILED DESCRIPTION OF THE INVENTION

Throughout this document, the phrases “hydrogenation metal” and “hydrogenation metals” refer to the Group VI metal or metals and the Group VIII metal or metals collectively. As used throughout this document, the term “Group VI metal” refers to the metals of Group VIB. As used throughout this document, the phrases “as the Group VI metal trioxide,” “reported as the Group VI metal trioxide,” “calculated as the Group VI metal trioxide,” “expressed as their oxides,” and analogous phrases for the Group VIII metals as their monoxides refer to the amount or concentration of Group VI metal or Group VIII metal, where the numerical value is for the respective oxide, unless otherwise noted. For example, nickel carbonate may be used, but the amount of nickel is stated as the value for nickel oxide. Contrary to normal practice, the catalysts in this invention do not contain phosphorus as an impregnated additive. Thus the catalysts in this invention are sometimes referred to in this document as phosphorus-free catalysts. In some instances, phosphorus may be present in the groups on the polymers of the catalyst.

As used throughout this document, the term “impregnation” when referring to impregnation of a carrier, means that the substance, solution, or mixture penetrates into the pores of the carrier.

The impregnation solutions used in the practice of this invention comprise a solvent, at least one Group VI metal, and at least one Group VIII metal, where the molar ratio of the Group VI metal to the Group VIII metal is about 1:1 to about 5:1.

The Group VI metal is molybdenum, tungsten, and/or chromium; preferably molybdenum or tungsten, more preferably molybdenum. The Group VIII metal is iron, nickel and/or cobalt, preferably nickel and/or cobalt. Preferred combinations of metals include a combination of nickel and/or cobalt and molybdenum and/or tungsten. When hydrodesulfurization activity of the catalyst is to be emphasized, a combination of cobalt and molybdenum is advantageous and preferred. When hydrodenitrogenation activity of the catalyst is to be emphasized, a combination of nickel and molybdenum and/or tungsten is advantageous and preferred. Another preferred combination of hydrogenation metals is nickel, cobalt and molybdenum.

The Group VI metal compound used to prepare the impregnation solution can be an oxide, an oxo-acid, or an ammonium salt of an oxo or polyoxo anion; these Group VI metal compounds are formally in the +6 oxidation state when the metal is molybdenum or tungsten. Oxides and oxo-acids are preferred Group VI metal compounds. Suitable Group VI metal compounds in the practice of this invention include chromium (III) oxide, ammonium chromate, ammonium dichromate, molybdenum trioxide, molybdic acid, ammonium molybdate, ammonium para-molybdate, tungsten trioxide, tungstic acid, ammonium metatungstate hydrate, ammonium para-tungstate, and the like. Preferred Group VI metal compounds include chromium (III) oxide, molybdenum trioxide, molybdic acid, ammonium para-tungstate, tungsten trioxide and tungstic acid. Combinations of any two or more Group VI metal compounds can be used.

The Group VIII metal compound used to prepare the impregnation solution is usually an oxide, carbonate, hydroxide, hydroxy-carbonate, or a salt. Suitable Group VIII metal compounds include, but are not limited to, iron oxide, iron hydroxide, iron nitrate, iron carbonate, iron hydroxy-carbonate, iron acetate, iron citrate, cobalt oxide, cobalt hydroxide, cobalt nitrate, cobalt carbonate, cobalt hydroxy-carbonate, cobalt acetate, cobalt citrate, nickel oxide, nickel hydroxide, nickel nitrate, nickel carbonate, nickel hydroxy-carbonate, nickel acetate, and nickel citrate. Preferred Group VIII metal compounds include iron hydroxide, iron carbonate, iron hydroxy-carbonate, cobalt hydroxide, cobalt carbonate, cobalt hydroxy-carbonate, nickel hydroxide, nickel carbonate, and nickel hydroxy-carbonate. A combination of two or more Group VIII metal compounds can be used.

One or more organic additives are optionally included, and may be a non-acidic organic additive and/or an acidic organic additive.

For the non-acidic organic additive, the term “non-acidic” as used throughout this document means that no acidic carboxylic groups are present in the additive. Non-acidic organic additives normally include compounds having at least two hydroxyl groups and two to about ten carbon atoms, and the (poly) ethers of these compounds. Some preferred, non-acidic organic additives have two hydroxyl groups. Suitable types of compounds for the non-acidic organic additive include aliphatic alcohols, ethers, including ethers of aliphatic alcohols, polyethers, saccharides, including monosaccharides and disaccharides, and polysaccharides. Examples of such compounds include, but are not limited to, glycerin, trimethylol ethane, trimethylol propane, ethylene glycol, diethylene glycol, trimethylene glycol, triethylene glycol, tributylene glycol, tetraethylene glycol, tetrapentylene glycol, propylene glycol, dipropylene glycol, ethylene glycol monobutyl ether, diethylene glycol monomethyl ether, diethylene glycol monoethyl ether, diethylene glycol monopropyl ether, diethylene glycol monobutyl ether, glucose, fructose, lactose, maltose, and saccharose. Preferred non-acidic organic additives include glycols such as diethylene glycol, triethylene glycol, and tetraethylene glycol. A combination of two or more organic additives can be used, if desired.

The optional acidic organic additive has at least one acid group and at least one functional group selected from a hydroxyl group and an acid group. Thus, at a minimum, the acidic organic additive has one acid group and one hydroxyl group, or two acid groups. As used herein, the term “acid group” means the —COOH moiety. The acidic organic additive preferably has at least two carboxylic acid moieties, and preferably has at least about three carbon atoms. It is sometimes preferred that the acidic organic additive has at least one hydroxyl group. Suitable acidic organic additives include citric acid, gluconic acid, lactic acid, malic acid, maleic acid, malonic acid, oxalic acid, tartaric acid, and the like. Citric acid is a preferred acidic organic additive. Combinations of acidic organic additives can be used.

The peroxomolybdocobaltate compounds of the invention can be used to provide the Group VI metal and Group VIII metal, when the Group VI metal is molybdenum and Group VIII metal is cobalt, to form catalysts according to the invention. One or more Group VI metal compounds and/or Group VIII metal compounds can be used in addition to the peroxomolybdocobaltate compound when forming catalysts of the invention, although use of a peroxomolybdocobaltate compound without an additional Group VI metal compound or Group VIII metal compound is preferred.

To dissolve the Group VI metal compound and the Group VIII metal compound, or a peroxomolybdocobaltate compound, a polar solvent is usually needed. In this invention, the polar solvent can be protic or aprotic, and is generally a polar organic solvent and/or water. Mixtures of polar solvents can be used, including mixtures comprising an aprotic solvent and a protic solvent. Suitable polar solvents include water, methanol, ethanol, n-propanol, isopropyl alcohol, acetonitrile, acetone, tetrahydrofuran, ethylene glycol, dimethylformamide, dimethylsulfoxide, methylene chloride, and the like, and mixtures thereof. Preferably, the polar solvent is a protic solvent; more preferably, the polar solvent is water or an alcohol, such as ethanol or isopropyl alcohol. Mixtures of two or more polar solvents can be used. Water is a preferred polar solvent.

When a monomer and a carrier are brought together and the monomer is polymerized before being contacted with an impregnation solution, (a solution containing a Group VI metal compound and a Group VIII metal compound, or a peroxomolybdocobaltate compound), the monomer can be polymerized in any solvent in which the monomer is soluble, including nonpolar solvents. After the polymerization, the solvent can be removed. When a monomer and a carrier are brought together and the monomer is polymerized before being contacted with an impregnation solution, removal of at least a portion of the solvent is preferred, especially when the solvent for polymerization will negatively affect the solubility of the Group VI metal compound and/or Group VIII metal compound, or the peroxomolybdocobaltate compound. Suitable solvents for the polymerization in the absence of the Group VI metal compound and/or Group VIII metal compound, or the peroxomolybdocobaltate compound, depend on the solubility of the monomer(s) employed. The solvent(s) used in the polymerization step can be present in the solution with the Group VI metal compound and Group VIII metal compound, or the peroxomolybdocobaltate compound, to the extent that the solvent(s) from the polymerization step do not cause the Group VI metal compound and/or Group VIII metal compound, or the peroxomolybdocobaltate compound, to precipitate.

When an impregnation solution and a carrier are brought together to form an impregnated carrier prior to contact with the monomer, the monomer may be dissolved in a solvent that may be the same or different than the solvent of the impregnation solution. Solvent(s) for the monomer depend on the solubility of the monomer(s) employed. It is preferred to employ the same solvent to dissolve the monomer and to form the impregnation solution, although different solvents can be used if desired.

Solvents that form impregnation solutions must be able to dissolve the Group VI metal compounds and Group VIII metal compounds that are used in forming the impregnation solutions used in the practice of this invention; such solvents are typically polar solvents.

When a monomer species, at least one Group VI metal compound, and at least one Group VIII metal compound are brought together prior to polymerization, the monomer species should be soluble in the solution containing at least one Group VI metal compound and at least one Group VIII metal compound. When an impregnation solution is brought into contact with the carrier and monomer species during polymerization, the same solubility considerations apply; namely, that the monomer species present should be soluble in the solution in the presence of at least one Group VI metal compound and at least one Group VIII metal compound. Often, for the monomer to be soluble in the solution containing the peroxomolybdocobaltate compound or at least one Group VI metal compound and at least one Group VIII metal compound, the monomer is at least somewhat soluble in the polar solvent in which the peroxomolybdocobaltate compound or the Group VI metal compound and Group VIII metal compound are dissolved.

Throughout this document, the term “monomer” is synonymous with the phrase “monomer species.” The monomer species typically has three or more carbon atoms, preferably three to about twelve carbon atoms, more preferably three to about ten carbon atoms, still more preferably three to about eight carbon atoms. The monomer species has carbon-carbon unsaturation as the polymerizable moiety, and at least one functional group comprising at least one heteroatom. It is theorized that the heteroatom(s) may form a bond or interaction with a metal ion, though formation of bonds or interactions is not required. Preferred monomers include functional groups which have one or more lone pairs of electrons. Preferably, the functional group of the monomer species comprises nitrogen, oxygen, phosphorus, and/or sulfur. Examples of suitable functional groups include hydroxyl groups, carboxyl groups, carbonyl groups, amino groups, amido groups, nitrile groups, amino acid groups, phosphate groups, thiol groups, sulfonic acid groups, and the like. Preferred functional groups include hydroxyl groups, ester groups, amido groups, and carboxyl-containing groups, especially carboxylic acid groups; more preferred are carboxylic acid groups and amido groups, especially amido groups.

Thus, suitable monomer species include acrylic acid, maleic acid, fumaric acid, crotonic acid, pentenoic acid, methacrylic acid, 2,3-dimethacrylic acid, 3,3-dimethacrylic acid, allyl alcohol, 2-sulfoethyl methacrylate, n-propyl acrylate, hydroxymethyl acrylate, 2-hydroxyethyl acrylate, 2-carboxyethyl acrylate, 3-ethoxy-3-oxopropyl acrylate, methylcarbamylethyl acrylate, 2-hydroxyethyl methacrylate, N-vinylpyrrolidone, acrylamide, methacrylamide, N-isopropylacrylamide, N-vinylacetamide, N-vinyl-N-methylacetamide, N-hydroxymethyl acrylamide, N-hydroxyethyl acrylamide, N-methoxymethyl acrylamide, N-ethoxymethyl acrylamide, vinyl sulfate, vinyl sulfonic acid, 2-propene-1-sulfonic acid, vinyl phosphate, vinyl phosphonic acid, dimethyl allyl phosphate, diethyl allyl phosphate, and the like. Preferred monomer species include acrylic acid, maleic acid, 2-carboxyethyl acrylate, acrylamide, and N-hydroxyethyl acrylamide. More preferred are acrylamide and acrylic acid, especially acrylamide. Two or more monomer species can be employed; when two or more monomer species are employed, co-polymers will be formed.

The amount of monomer used to form the catalysts of this invention is expressed as wt % relative to the total weight of the other components used to form the catalyst, excluding the solvent. As used throughout this document, the phrases “other components used to form the catalyst” and “other catalyst components” refer to the carrier and the chemical substances that provide the hydrogenation metals to the catalyst. For example, if the total weight of the other components of the catalyst (other than the solvent) is 100 grams, 10 wt % of monomer is 10 grams. In the practice of this invention, the amount of monomer is generally about 1.5 wt % or more, preferably in the range of about 1.5 wt % to about 35 wt %, although amounts outside these ranges are within the scope of the invention, relative to the total weight of the other components of the catalyst, which include the carrier, Group VI metal compound, and Group VIII metal compound, where the Group VI metal compound and Group VIII metal compound are expressed as their Group VI metal and Group VIII metal oxides; the weight of any solvent is excluded. More preferably, the amount of monomer is in the range of about 3 wt % to about 30 wt %, even more preferably in the range of about 5 wt % to about 25 wt %, still more preferably in the range of about 10 wt % to about 25 wt %, relative to the total weight of the other components of the catalyst excluding the solvent.

An inhibitor (e.g., a radical scavenger) can be included with the monomer to prevent premature polymerization of the monomer species. Suitable inhibitors will vary with the particular monomer(s). Appropriate inhibitors will not have an adverse effect on at least one Group VI metal compound and at least one Group VIII metal compound, when present in the mixture before polymerization is initiated. Desirably, the inhibitor is neutralized or removed (e.g., by evaporation or introduction of an initiator) when it is desired to start the polymerization reaction.

Although the components used in forming an impregnation solution can be combined in any order, it is recommended and preferred that one component is suspended or dissolved in the solvent prior to the introduction of the other components. Preferably, the Group VIII metal compound is introduced first; more preferably, the Group VI metal compound is introduced after the Group VIII metal compound. Stirring may be employed when forming the solution, but can be stopped once the solution is homogeneous. Similar considerations apply when a monomer, at least one Group VI metal compound, and at least one Group VIII metal compound are brought together; it is preferable to combine the compounds of the hydrogenation metals with the solvent, usually a polar solvent, then add the monomer.

Combining of the components of an impregnation solution can be done at ambient conditions, i.e., room temperature and ambient pressure. Elevated temperatures are sometimes necessary to assist in the dissolution of the components, particularly the Group VI compound and the Group VIII compound. Such elevated temperatures are typically in the range of about 50° C. to about 95° C., preferably about 60° C. to about 95° C. Temperatures in excess of about 95° C. and/or elevated pressures can be applied (e.g., hydrothermal preparation), but are not required. If a monomer for which polymerization is thermally initiated is to be included in the solution, either the temperature to which the solution is heated is kept below the temperature at which polymerization is initiated, or, preferably, the monomer species is added after any heating of the solution is completed.

It is convenient to prepare solutions having concentrations that are practical for further intended use of the solution. These solutions can be employed, as embodied in this invention, to form a supported catalyst. Suitable concentrations based on the Group VI metal (or total thereof, if more than one Group VI metal is present in the composition), are typically in the range of about 1.39 mol/L to about 6 mol/L, preferably in the range of about 2.1 mol/L to about 4.2 mol/L.

Methods for preparing more-concentrated impregnation solutions are known, and are described for example in International Publication No. WO 2011/023668.

The impregnation solutions for the invention, formed as described above, are solutions comprising a peroxomolybdocobaltate, or a Group VI metal compound and a Group VIII metal compound, or in a polar solvent. The concentrations of the Group VI metal and Group VIII metal, and the preferences therefor, are as described above. In these solutions, the molar ratio of the Group VI metal to the Group VIII metal is about 1:1 to about 5:1.

When combinations of reagents are used in forming the solutions, as mentioned above, a mixture of species having different metals will be present in the solution. For example, if a molybdenum compound and a tungsten compound are used, the product solution will include molybdenum and tungsten. In another example, if a cobalt compound and a nickel compound are used, the solution will include cobalt and nickel. Mixtures of reagents such that Group VI metal compounds in which the Group VI metals of the compounds are different and Group VIII metal compounds in which the Group VIII metals of the compounds are different can be used in forming the solution compositions if desired.

The processes of the invention for forming catalysts comprise I) bringing together a carrier, one or more monomer species, a solvent, and at least one Group VI metal compound and at least one Group VIII metal compound or a peroxomolybdocobaltate compound, in any of the following combinations:
a) a carrier, one or more monomer species, and a solvent,
b) a carrier, one or more monomer species, and a peroxomolybdocobaltate compound, or at least one Group VI metal compound and at least one Group VIII metal compound, or
c) a carrier and an impregnation solution, forming an impregnated carrier, followed by mixing the impregnated carrier with one or more monomer species,
   to form a monomer-containing mixture, where said monomer species is soluble in the solvent, and has carbon-carbon unsaturation and at least one functional group comprising at least one heteroatom. When the polymerization initiator is a chemical substance, the initiator can be included with any of the combinations a), b), and c) above in Step I). Step II) comprises initiating polymerization of the monomer species in the monomer-containing mixture to form a polymerized product. Step III) is performed when the monomer-containing mixture in I) is formed as in a), and comprises either
A) contacting an impregnation solution and the monomer-containing mixture during the polymerization in II), or
B) contacting the polymerized product and an impregnation solution.
   A supported catalyst is formed. In the processes, the molar ratio of the Group VI metal to the Group VIII metal is about 1:1 to about 5:1. Impregnation solutions employed in the process comprise a polar solvent, at least one Group VI metal, and at least one Group VIII metal. Removing excess solvent from the supported catalyst, e.g., by drying, is a recommended further step.

An initiator can be included in the above process. When used in the above process, the initiator can be introduced in a), b), or c). When combining the ingredients as in c), the initiator is introduced after the impregnated carrier has been formed.

A feature of this invention is that there is little or no aggregation of carrier particles in the processes of the invention for forming catalysts, especially when a peroxomolybdocobaltate compound is used. Non-aggregated catalyst particles produced are generally free-flowing and do not adhere to each other. When an initiator is used, small amounts of the impregnation solution may exit the carrier and some polymer may be formed external to the carrier, resulting in some aggregation which is easily removed by applying minimal force (e.g., tapping by hand) to any aggregated particles. Another feature of this invention is that the carrier particles are unaltered in size and shape by the processes of the invention for forming catalysts. For example, carrier particles with an average particle size of about 2 mm become catalyst particles with an average particle size of about 2 mm.

In the processes of the invention for forming catalysts, all of the components in the impregnation solution must be dissolved before initiating the impregnation step. When at least one Group VI metal compound and at least one Group VIII metal compound, or a peroxomolybdocobaltate compound, form part of the monomer-containing mixture, the monomer species is preferably combined with the mixture after any heating of the mixture is finished. For monomers of thermally-initiated polymerizations, the temperature during formation of the monomer-containing mixtures are kept below the initiation temperature for polymerization.

Because polymerization reactions are usually exothermic, the reaction vessel should be heat resistant at least to the temperatures reached by the polymerization reaction.

In preferred embodiments, the process comprises forming an impregnation solution of a peroxomolybdocobaltate compound or a Group VI metal compound and a Group VIII metal compound in a polar solvent, optionally adding a heat-activated chemical substance initiator and then the carrier to the impregnation solution, followed by aging the mixture of the impregnation solution and the carrier for a period of time, e.g., 0.5 to 10 hours at low heat (e.g., 30° C. to 60° C.) to promote the impregnation solution into the pores of the carrier. When the impregnation solution contains a chemical substance initiator, after aging, the mixture is preferably heated at one or more temperatures at which the polymerization reaction starts. Generally, the temperature(s) chosen are at or slightly above the temperature needed to initiate polymerization. Control of heat release during the polymerization is recommended to avoid driving a portion of the impregnation solution out of the carrier pores, which reduces the amount of Group VI metal and Group VIII metal in the final catalyst. The polymerization reaction can be monitored via the exotherm produced. When the polymerization reaction is over, the product preferably is dried to remove the solvent(s). At atmospheric pressure, drying (solvent removal) is preferably at a temperature of about 25° C. to about 200° C., more preferably about 50° C. to about 150° C., even more preferably about 75° C. to about 125° C. Reduced pressure and/or vacuum conditions can be used for drying. The drying temperature(s) should be lower than the decomposition temperature of the polymer; the decomposition temperature of the polymer may vary with one or more of the catalyst features (carrier, Group VI metal, Group VIII metal, and amounts thereof).

The monomer-containing mixture includes at least one carrier and at least one monomer species. At least one Group VI metal compound and at least one Group VIII metal compound, or an impregnation solution are optionally included with the carrier and one or more monomer species in forming the monomer-containing mixture. Inclusion of a peroxomolybdocobaltate compound or at least one Group VI metal compound and at least one Group VIII metal compound in the monomer-containing mixture is recommended and preferred. When at least one Group VI metal compound and at least one Group VIII metal compound are not included in the monomer-containing mixture, an impregnation solution can be mixed with the polymerized product of the monomer-containing solution; alternatively, an impregnation solution can be brought into contact with the monomer-containing mixture during polymerization.

In the processes of this invention, the polymerization of the monomer species to form the polymer often employs at least one initiator. Initiators include heat, radiation (e.g., UV), chemical substances, and combinations of these. When the initiator is a chemical substance, it usually remains with the supported catalyst, and may affect catalyst performance. Thus, when more than one initiator can be chosen, it may be useful to run tests to determine which combination of initiator(s) and selected monomer(s) allows for optimal catalyst performance. Another consideration is that the selected initiator(s) and monomer(s) should not adversely affect the solubility of the Group VI metal and/or Group VIII metal compounds in the impregnation solution (e.g., by causing precipitation). For example, in some polymerizations of acrylic acid with persulfate salts as initiators, it was found that potassium persulfate was a better initiator than ammonium persulfate for catalysts containing nickel and molybdenum (see International Publication No. WO 2014/056846). In polymerizations of acrylamide, potassium persulfate and ammonium persulfate are preferred initiators when a chemical substance initiator is used. The effect of a particular initiator may vary with the concentration of hydrogenation metals present in the catalyst, the monomer, and the conditions under which catalysis is performed.

When the initiator is a chemical substance (or a chemical substance in combination with heat or radiation), any suitable chemical substance initiator that initiates polymerization of the monomer, and does not adversely affect the solubility of the monomer, Group VI metal compound and/or Group VIII metal compounds, or peroxomolybdocobaltate compound, present in the solution, can be used. Preferred chemical substance initiators include persulfate salts, such as sodium persulfate, potassium persulfate, and ammonium persulfate; more preferred are potassium persulfate and ammonium persulfate. Hydrogen peroxide is a suitable initiator, but usually needs to be used in larger amounts relative to the monomer as compared to persulfate salts, at least when the monomer is acrylamide. Further, it has been found that the carrier has an effect on the polymerization when the initiator is hydrogen peroxide, with polymerization observed when alumina or titania is the carrier. Polymerization is not observed with hydrogen peroxide as the initiator when silica or a combination of alumina and silica is the carrier. Preferably, when the initiator is hydrogen peroxide, the carrier is alumina, titania, or alumina containing titania, more preferably alumina.

Suitable initiators also depend on the (polymerization) reactivity of the selected monomer(s). For example, ammonium persulfate or potassium persulfate in combination with an increase in temperature from room temperature to 80° C. is a suitable combination of initiators for polymerization of acrylic acid or acrylamide. However, for monomers that polymerize less readily, a different type of initiator or a different combination of initiators may be required.

The amount of a chemical substance initiator that provides a high yield of polymer can vary with the initiator, monomer, metals, and carrier. It has been found that persulfate salts are preferably about 1.25 mmol or more, or about 1.25 mmol to about 3 mmol, per mole of monomer, more preferably about 1.5 mmol or more, or about 1.5 mmol to about 2.75 mmol, per mole of monomer, especially when the monomer is acrylamide. In terms of weight, persulfate salts are preferably about 0.4 wt % or more, or about 0.4 wt % to about 1.15 wt %, relative to the weight of the monomer, more preferably about 0.48 wt % or more, or about 0.48 wt % to about 1.05 wt %, relative to the weight of the monomer, especially when the monomer is acrylamide.

In some preferred embodiments, the amount of persulfate salt that provides a high yield of polymer is about 1.5 mmol or more, preferably about 1.75 mmol or more, still more preferably about 2 mmol or more, even more preferably about 2.25 mmol or more, per mole of monomer, especially when the initiator is ammonium persulfate, and especially when the monomer is acrylamide. In other preferred embodiments, the amount of persulfate salt that provides a high yield of polymer is about 1.5 mmol to about 2.5 mmol, preferably about 1.75 to about 2.5 mmol, more preferably about 2 mmol to about 2.5 mmol, still more preferably about 2.25 mmol to about 2.5 mmol, per mole of monomer, especially when the initiator is ammonium persulfate, and especially when the monomer is acrylamide.

In terms of weight, in some preferred embodiments, the amount of persulfate salt that provides a high yield of polymer is about 0.48 wt % or more, preferably about 0.55 wt % or more, still more preferably about 0.63 wt % or more, even more preferably about 0.72 wt % or more, relative to the weight of the monomer, especially when the initiator is ammonium persulfate, and especially when the monomer is acrylamide. In other preferred embodiments, the amount of persulfate salt that provides a high yield of polymer is 0.48 wt % to about 0.8 wt %, preferably about 0.55 wt % to about 0.8 wt %, more preferably about 0.63 wt % to about 0.8 wt %, still more preferably about 0.72 wt % to about 0.8 wt %, relative to the weight of the monomer, especially when the initiator is ammonium persulfate, and especially when the monomer is acrylamide.

In some other preferred embodiments, the amount of persulfate salt that provides a high yield of polymer is about 1.9 mmol or more, preferably about 2 mmol or more, still more preferably about 2.25 mmol or more, even more preferably about 2.5 mmol or more, per mole of monomer, especially when the initiator is potassium persulfate, and especially when the monomer is acrylamide. In other preferred embodiments, the amount of persulfate salt that provides a high yield of polymer is about 1.9 mmol to about 3 mmol, preferably about 2 to about 3 mmol, more preferably about 2.25 mmol to about 2.75 mmol, still more preferably about 2.5 mmol to about 2.75 mmol, per mole of monomer, especially when the initiator is potassium persulfate, and especially when the monomer is acrylamide.

In terms of weight, in some other preferred embodiments, the amount of persulfate salt that provides a high yield of polymer is about 0.75 wt % or more, preferably about 0.8 wt % or more, still more preferably about 0.85 wt % or more, still more preferably about 0.95 wt % or more, relative to the weight of the monomer, especially when the initiator is potassium persulfate, and especially when the monomer is acrylamide. In other preferred embodiments, the amount of persulfate salt that provides a high yield of polymer is about 0.75 wt % to about 1.15 wt %, preferably about 0.8 wt % to about 1.15 wt %, more preferably about 0.85 wt % to about 1.05 wt %, still more preferably about 0.95 wt % to about 1.05 wt %, relative to the weight of the monomer, especially when the initiator is potassium persulfate, and especially when the monomer is acrylamide.

One of the features of this invention is that in some instances, the components of the monomer-containing solution can act as an initiator for the polymerization reaction when a peroxomolybdocobaltate compound is the source of the Group VI metal and the Group VIII metal. In these instances, the polymerization reaction initiates only when the peroxomolybdocobaltate compound and carrier are present with the monomer. When either the carrier or the peroxomolybdocobaltate compound is absent, the polymerization does not start without an initiator. Advantageously, this permits control of the polymerization initiation by excluding the either the carrier or preferably, the peroxomolybdocobaltate compound, from the solution until initiation of the polymerization reaction is desired. For these initiator-free polymerizations, the carrier is usually alumina, alumina containing silica, alumina containing boria, alumina containing titania, or a mixture of any two or more of these carriers; preferably the carrier is alumina. After impregnation of the peroxomolybdocobaltate compound and monomer into the carrier, typically at ambient temperatures, polymerization without a chemical initiator generally involves heating the impregnated carrier (monomer-containing solution) to one or more temperatures of about 50° C. or above, preferably about 50° C. to about 100° C.

For the polymerizations in which a combination of a peroxomolybdocobaltate compound and a carrier appear to initiate polymerization, a carrier having an isoelectric point of about 4 or more at 25° C. is effective. Initiation of polymerization occurred when the carrier was alumina (isoelectric point of about 7 or 8) and titania (isoelectric point of about 4 to about 8), but initiation has not been observed when the carrier was silica (isoelectric point of about 1 to about 3).

The peroxomolybdocobaltate compounds of the invention generally have higher amounts of cobalt relative to molybdenum than other hydroprocessing catalyst systems. In the peroxomolybdocobaltates, the Co:Mo ratio is generally about 0.5:2 to about 1.5:2, more preferably about 0.75:2 to about 1.25:2, even more preferably about 1:2. It is believed that the peroxomolybdocobaltate compounds comprise Anderson complexes (e.g., Co₃[Co₂Mo₁₀O₃₈H₄]), and/or similar moieties.

In the practice of this invention, the peroxomolybdocobaltate compounds are prepared by first contacting a molybdenum compound and an oxidant, preferably hydrogen peroxide, to form a molybdenum-containing mixture. The molybdenum compound is dissolved in a polar solvent; polar solvents and the preferences therefor are as described above. In preferred embodiments, the molybdenum-containing mixture is heated at one or more temperatures in the range of about 30° C. to about 90° C., preferably about 40° C. to about 80° C., more preferably about 50° C. to about 75° C.

The molybdenum-containing mixture is combined with a cobalt compound to form a molybdenum-cobalt mixture, and the molybdenum-cobalt mixture is spray dried to obtain the peroxomolybdocobaltate compound. Preferably, the molybdenum-containing mixture is at one or more temperatures in the range of about 30° C. to about 75° C., preferably about 40° C. to about 65° C., during the combining with the cobalt compound. Spray drying is typically conducted with an inlet temperature of about 150° C. or more, preferably about 180° C., and an outlet temperature of about 100° C.

Suitable molybdenum compounds and cobalt compounds and preferences therefor for forming the peroxomolybdocobaltate compounds are as described above for the Group VI metal compounds and Group VIII metal compounds when added separately to for the catalysts of the invention.

Suitable oxidants for forming peroxomolybdocobaltates include hydrogen peroxide. Hydrogen peroxide can be used at any desired concentration, but solutions having higher concentrations, e.g., about 30% or more, are preferred.

When the oxidant is hydrogen peroxide, the molybdenum to hydrogen peroxide molar ratio is in the range of about 1:4 to about 1:7, preferably about 1:5 to about 1:6. The molybdenum compound and cobalt compound are in amounts such that the Co:Mo ratio is about 0.5:2 to about 1.5:2, more preferably about 0.75:2 to about 1.25:2, even more preferably about 1:2.

As used throughout this document, the term “carrier” is used to mean a catalyst support, and the term “carrier” can be used interchangeably with the term “support”. Throughout this document, the term “carrier” refers to a carrier which is in the solid form or is pre-shaped. Such a carrier remains predominantly in the solid form when contacted with a solvent. The term “carrier” does not refer to precursor salts, such as sodium aluminate, which dissolve almost completely in one or more solvents, especially polar solvents.

The carrier is generally carbon and/or an inorganic oxide which is a particulate porous solid. Carbon can be used in combinations with one or more inorganic oxides such as alumina, silica, titania, or boria; silica and especially alumina are preferred for these combinations. An inorganic oxide carrier may be composed of conventional oxides, e.g., alumina, silica, alumina containing silica (e.g., silica-alumina, alumina with silica-alumina dispersed therein, alumina-coated silica, silica-coated alumina), alumina containing boria, alumina containing titania, magnesia, zirconia, boria, and titania, as well as combinations of these oxides. Suitable carriers also include transition aluminas, for example an eta, theta, or gamma alumina. Preferred carriers include silica, alumina, silica-alumina, alumina with silica-alumina dispersed therein, alumina-coated silica, or silica-coated alumina, especially alumina or alumina containing up to about 20 wt % of silica, preferably up to about 12 wt % of silica, more preferably about 0.25 wt % to about 10 wt %, still more preferably about 0.5 wt % to about 2 wt %, or about 5 wt % to about 10 wt % of silica. A carrier containing a transition alumina, for example an eta, theta, or gamma alumina, is particularly preferred, and a gamma-alumina carrier is most preferred.

Another preferred carrier is alumina which contains boron (or boria) or titanium (or titania), especially boria-alumina or titania-alumina. When the alumina contains boron, the boron is preferably in an amount of about 0.5 wt % to about 20 wt %, more preferably about 1 wt % to about 15 wt %, even more preferably about 2 wt % to about 10 wt %, as B₂O₃. When the alumina contains titanium, the titanium is preferably in an amount of about 1 wt % to about 50 wt %, more preferably about 5 wt % to about 30 wt %, even more preferably about 15 wt % to about 25 wt %, as TiO₂.

The carrier is normally employed in a conventional manner in the form of spheres or, preferably, extrudates. Examples of suitable types of extrudates have been disclosed in the literature; see for example U.S. Pat. No. 4,028,227. Highly suitable for use are cylindrical particles (which may or may not be hollow) as well as symmetrical and asymmetrical polylobed particles (2, 3 or 4 lobes). Carrier particles are typically calcined at a temperature in the range of about 400° to about 850° C. before use in forming the catalysts of this invention.

To introduce other elements such as boron, silicon, and/or titanium into a carrier, the carrier can be co-extruded with a compound containing the desired atoms, co-precipitated with a compound containing the desired atoms, or impregnated with a compound containing the desired atoms. For the co-extrusions, the compounds are often oxides or oxygen-containing acids (e.g., HBO₂, H₃BO₃, or B₂O₃ for boron).

When introducing other elements such as boron, silicon, and/or titanium into an inorganic oxide carrier, typically, enough of the compound containing boron to result in about 0.5 wt % to about 20 wt %, preferably about 1 wt % to about 10 wt %, as B₂O₃ is used; enough of the compound containing titanium to result in about 1 wt % to about 50 wt %, more preferably about 5 wt % to about 30 wt %, even more preferably about 15 wt % to about 25 wt %, as TiO₂, is used; enough of the compound containing silicon to result in 0.5 wt % to about 15 wt %, preferably about 0.75 to about 10 wt %, more preferably about 0.8 to about 8 wt %, as SiO₂ is used. Preferred carriers of this type include alumina containing boron, alumina containing silicon, alumina containing titanium, or a combination of any two or more of these.

Although particular pore dimensions are not required in the practice of this invention, the carrier's pore volume (measured via N₂ adsorption) will generally be in the range of about 0.25 to about 1 mL/g. The specific surface area will generally be in the range of about 50 to about 400 m²/g, preferably about 100 to about 300 m²/g, more preferably about 150 to about 275 m²/g (measured using the Braun-Emmet-Teller (BET) N₂ adsorption method). Generally, the catalyst will have a median pore diameter in the range of about 5 nm to about 20 nm, preferably in the range of about 6 nm to about 15 nm, as determined by N₂ adsorption. Preferably, about 60% or more of the total pore volume will be in the range of approximately 2 nm from the median pore diameter. The values for the pore size distribution and the surface area given above are determined after calcination of the carrier at about 500° C. for one hour.

The carrier particles typically have an average particle size of about 0.5 mm to about 5 mm, more preferably about 1 mm to about 3 mm, and still more preferably about 1 mm to about 2 mm. Because the size and shape of the carrier is not altered by the process for forming the catalyst, the catalyst generally has an average particle size of about 0.5 mm to about 5 mm, more preferably about 1 mm to about 3 mm, and still more preferably about 1 mm to about 2 mm.

The amount of carrier used to form the catalysts of this invention is about 40 wt % to about 80 wt %, preferably about 50 wt % to about 70 wt %, and more preferably about 60 wt % to about 70 wt %, relative to the total weight of the carrier and hydrogenation metals, where the hydrogenation metals are expressed as their oxides, i.e., excluding the solvent and the monomer species.

Methods for impregnating the carrier are known to the skilled artisan. Preferred methods include co-impregnation of at least one Group VI metal compound and at least one Group VIII metal compound. In the processes of this invention for forming catalysts, only one impregnation step is needed. In a single impregnation step, once the carrier and impregnation solution are brought together, the mixture is usually homogenized until virtually all of the impregnation solution is taken up into the catalyst. In this technique, which is known in the art as pore volume impregnation or as incipient wetness impregnation, the impregnation solution will be taken up virtually completely by the pores of the catalyst, which makes for an efficient use of chemicals, and avoids dust in the product.

There can be a wide number of variations on the impregnation method. Thus, it is possible to apply a plurality of impregnating steps, the impregnating solutions to be used containing one or more of the component precursors that are to be deposited, or a portion thereof (sequential impregnation). Instead of impregnating techniques, there can be used dipping methods, spraying methods, and so forth. When carrying out multiple impregnation, dipping, etc., steps, drying may be carried out between impregnation steps. However, a single impregnation step is preferred because it is a faster, simpler process, allowing for a higher production rate, and is less costly. Single impregnation also tends to provide catalysts of better quality.

In a preferred one step impregnation procedure, a solution with the required concentrations of Group VI metal and Group VIII metal is prepared, and then monomer and initiator (if used) are added, preferably at room temperature. More preferably, the monomer is added and then the initiator (if used) is added. If necessary, the volume of the impregnation solution containing metals, monomer, and initiator (if used) is adjusted, usually by dilution, to match the carrier pore volume. One or more organic additives may be added at this point if desired. The temperature of the solution is preferably kept below about 50° C. during the impregnation solution preparation. The impregnation solution is then combined with the carrier at about 90% to about 105% saturation of its pores, more preferably about 98% to about 100% saturation of its pores. The catalyst is typically allowed to age for several minutes or longer at one or more temperatures of about 50° C. or lower. After ageing, polymerization is induced. In some embodiments, polymerization is induced by heating the catalysts at about 70° C. to about 90° C., preferably about 75° C. to about 85° C., for about 30 minutes or more. Often, the polymerization can be monitored by measuring the exotherm released during polymerization. Once polymerization has completed, the catalysts are normally dried at one or more temperatures between about 50° C. and about 150° C., preferably about 50° C. to about 80° C.

In a preferred two step impregnation procedure, a solution with the required concentrations of Group VI metal and Group VIII metal is prepared, and then, if necessary, the volume of the impregnation solution containing the metals is adjusted, usually by dilution, to match the carrier pore volume. This solution is combined with the carrier and the resultant solid is dried at one or more temperatures between about 50° C. and about 150° C., preferably about 50° C. to about 80° C. In the second impregnation step, a solution containing the monomer and the initiator (if used) is prepared in deionized water. The monomer-containing solution is combined with the metals-impregnated carrier at about 90% to about 105% saturation of its pores, more preferably about 98% to about 100% saturation of its pores. The metals-impregnated carrier is typically allowed to age for about 60 minutes or more at one or more temperatures about 50° C. or lower, more preferably about 40° C. or lower. After aging, polymerization is induced. In some embodiments, polymerization is induced by heating the catalysts at about 70° C. to about 90° C., preferably about 75° C. to about 85° C., for about 30 minutes or more. Often, the polymerization can be monitored by measuring the exotherm released during polymerization. Once polymerization has completed, the catalysts are normally dried at one or more temperatures between about 50° C. and about 150° C., preferably about 50° C. to about 80° C.

When at least one Group VI metal compound and at least one Group VIII metal compound form part of the monomer-containing mixture, polymerization of the monomer species is preferably performed after the impregnation step, although polymerization can be started during impregnation of the carrier. If polymerization is carried out after impregnation, the polymerizing can be performed before or during removal of excess solvent if excess solvent removal is performed; preferably, polymerization is performed before removal of excess solvent. Similarly, when an impregnation solution and a carrier are brought together to form an impregnated carrier which is then mixed with a monomer, polymerization is preferably performed before removal of excess solvent, if excess solvent removal is performed. It is recommended and preferred to minimize solvent evaporation during the polymerization step.

In the processes of this invention, polymerization can be carried out in the usual manner, by exposing the monomer species to an initiator in an amount suitable to polymerize at least a portion of the monomer. Polymerization can be carried out without an initiator by heating the monomer-containing solution to about 50° C. or above when both the metals and the carrier are present, and at least a portion of the metals are in the form of a peroxomolybdocobaltate compound. Whether or not an initiator is used, any polymerization inhibitor needs to be inactivated when starting the polymerization reaction.

When at least one Group VI metal compound and at least one Group VIII metal compound do not form part of the monomer-containing mixture, polymerization is initiated in the presence of the carrier before impregnation, and an impregnation solution is combined with the monomer-containing mixture during polymerization or after polymerization has ended.

The polymer in the catalyst has a carbon backbone and comprises functional groups which have one or more lone pairs of electrons. Preferably, the functional group of the monomer species comprises nitrogen, oxygen, phosphorus, and/or sulfur. Examples of suitable functional groups include hydroxyl groups, carboxyl groups, carbonyl groups, amino groups, amido groups, nitrile groups, amino acid groups, phosphate groups, thiol groups, sulfonic acid groups, and the like. Preferred functional groups include hydroxyl groups, ester groups, amido groups, and carboxyl-containing groups, especially carboxylic acid groups; more preferred are carboxylic acid groups and amido groups, especially amido groups.

Examples of polymers formed as part of the catalysts of the invention include, but are not limited to, polyacrylic acid, polymaleic acid, polyfumaric acid, polycrotonic acid, poly(pentenoic) acid, polymethacrylic acid, polydimethacrylic acid, poly(allyl alcohol), poly(2-sulfoethyl) methacrylate, poly(n-propyl) acrylate, poly(hydroxymethyl) acrylate, poly(2-hydroxyethyl) acrylate, poly(2-carboxyethyl) acrylate, poly(3-ethoxy-3-oxopropyl) acrylate, poly(methylcarbamylethyl) acrylate, poly(2-hydroxyethyl) methacrylate, polyvinylpyrrolidone, polyacrylamide, polymethacrylamide, poly(N-isopropyl) acrylamide, polyvinylacetamide, polyvinyl-N-methylacetamide, poly(N-hydroxymethyl) acrylamide, poly(N-hydroxyethyl) acrylamide, poly(N-methoxymethyl) acrylamide, poly(N-ethoxymethyl) acrylamide, polyvinyl sulfate, polyvinyl sulfonic acid, poly(2-propyl)-1-sulfonic acid, polyvinyl phosphate, polyvinyl phosphonic acid, poly(dimethyl allyl phosphate), poly(diethyl allyl phosphate), polyvinyl phosphonic acid, and the like. Preferred polymers include polyacrylic acid, polymaleic acid, polyfumaric acid, poly(2-carboxyethyl) acrylate, polyacrylamide, and poly(N-hydroxyethyl) acrylamide; more preferred are polyacrylamide and polyacrylic acid, especially polyacrylamide. As noted above, two or more monomer species can be employed; in such instances, the polymer formed is a co-polymer, which can be a co-polymer of any two or more of the polymers listed above.

Although the monomers used to form the supported catalyst will often be soluble in a solvent, the polymer formed from the monomer(s) does not need to be soluble in the solvent(s) used in forming the catalysts.

The processes of the present invention yield supported catalysts in which the Group VIII metal is usually present in an amount of about 1 to about 10 wt %, preferably about 3 to about 8.5 wt %, calculated as a monoxide. When the Group VI metal in the catalyst is molybdenum, it will usually be present in an amount of about 35 wt % or less, preferably in an amount of about 15 to about 35 wt %, calculated as molybdenum trioxide.

When at least one Group VI metal compound and at least one Group VIII metal compound, or an impregnation solution are included before or during polymerization, a supported catalyst is obtained at the end of the polymerization step. If instead a polymerized product is formed and then contacted with an impregnation solution after polymerization, a supported catalyst is obtained at the end of the impregnation step or steps.

Optionally, excess solvent is removed from the supported catalyst. The removing of excess solvent may be carried out in air, under vacuum, or in the presence of an inert gas. Solvent removal is preferably achieved by drying the supported catalyst. Drying of the supported catalyst is conducted under such conditions that at least a portion of the polymer remains in the catalyst, i.e., the polymer is not completely removed by decomposition. Thus, the drying conditions to be applied depend on the temperature at which the particular polymer decomposes; decomposition can include combustion when the drying is conducted in the presence of oxygen. In these processes of the invention, drying should be carried out under such conditions that about 50% or more, preferably about 70% or more, more preferably about 90% or more, of the polymer is still present in the catalyst after drying. It is preferred to keep as much of the polymer as possible in the supported catalyst during drying; however, it is understood that loss of some of the polymer during the drying step cannot always be avoided, at least for more easily decomposed polymers. A drying temperature below about 270° C. may be necessary, depending on the polymer. In some embodiments, the drying temperature is preferably about 25° C. to about 200° C., more preferably about 50° C. to about 150° C., even more preferably about 75° C. to about 125° C.; the drying temperature(s) should be lower than the decomposition temperature of the polymer. Reduced pressure and/or vacuum conditions can be used for drying.

As mentioned above, the supported catalysts of this invention comprise a carrier, at least one Group VI metal, at least one Group VIII metal, and a polymer, where the molar ratio of the Group VI metal to the Group VIII metal is about 1:1 to about 5:1, and the polymer has a carbon backbone and comprises functional groups having at least one heteroatom. The carriers and the preferences therefor are as described above. The carrier in the supported catalysts of this invention is in an amount of about 40 wt % to about 80 wt %, preferably about 50 wt % to about 70 wt %, and more preferably about 60 wt % to about 70 wt %, relative to the total weight of the carrier and hydrogenation metals, where the hydrogenation metals are expressed as their oxides, i.e., excluding the polymer. The hydrogenation metals and the preferences therefor are as described above. In the polymers, the carbon backbone is sometimes referred to as a carbon-carbon backbone, where the backbone is the main chain of the polymer. Polymers in the supported catalysts and the preferences therefor are as described above.

Optionally, catalysts of the invention may be subjected to a sulfidation step (treatment) to convert the metal components to their sulfides. In the context of the present specification, the phrases “sulfiding step” and “sulfidation step” are meant to include any process step in which a sulfur-containing compound is added to the catalyst composition and in which at least a portion of the hydrogenation metal components present in the catalyst is converted into the sulfidic form, either directly or after an activation treatment with hydrogen. Suitable sulfidation processes are known in the art. The sulfidation step can take place ex situ to the reactor in which the catalyst is to be used in hydrotreating hydrocarbon feeds, in situ, or in a combination of ex situ and in situ to the reactor.

Ex situ sulfidation processes take place outside the reactor in which the catalyst is to be used in hydrotreating hydrocarbon feeds. In such a process, the catalyst is contacted with a sulfur compound, e.g., an organic or inorganic polysulfide or elemental sulfur, outside the reactor and, if necessary, dried, preferably in an inert atmosphere. In a second step, the material is treated with hydrogen gas at elevated temperature in the reactor, optionally in the presence of a feed, to activate the catalyst, i.e., to bring the catalyst into the sulfided state.

In situ sulfidation processes take place in the reactor in which the catalyst is to be used in hydrotreating hydrocarbon feeds. Here, the catalyst is contacted in the reactor at elevated temperature with a hydrogen gas stream mixed with a sulfiding agent, such as hydrogen sulfide or a compound which under the prevailing conditions is decomposable into hydrogen sulfide (e.g., dimethyl disulfide). It is also possible to use a hydrogen gas stream combined with a hydrocarbon feed comprising a sulfur compound which under the prevailing conditions is decomposable into hydrogen sulfide. In the latter case, it is possible to sulfide the catalyst by contacting it with a hydrocarbon feed comprising an added sulfiding agent such as dimethyl disulfide (spiked hydrocarbon feed), and it is also possible to use a sulfur-containing hydrocarbon feed without any added sulfiding agent, since the sulfur components present in the feed will be converted into hydrogen sulfide in the presence of the catalyst. Combinations of the various sulfiding techniques may also be applied. The use of a spiked hydrocarbon feed may be preferred.

When the catalyst is subjected to an in situ sulfidation step, the catalyst is exposed to high temperatures in the presence of oil and water formed during the process before sulfidation is complete. This exposure to high temperatures in the presence of oil and water does not appear to adversely affect catalyst activity. Without wishing to be bound by theory, it is thought that the polymer is more resistant to leaching or evaporation in comparison to catalysts described in the art that have low molecular weight organic additives.

The catalyst compositions of this invention are those produced by the above-described process, whether or not the process included an optional sulfiding step.

Without wishing to be bound by theory, both the observed greater dispersion of the hydrogenation metals and weak (low) metal-support interaction are achieved by employing monomers having functional groups as described above to form polymers in the supported catalysts. Such polymers are hypothesized to help disperse the hydrogenation metals throughout the pore network. Also without wishing to be bound by theory, hydrogenation metals are believed to interact with the polymer, which disperses the hydrogenation metals in the pore spaces of the support. It is also hypothesized that activation of the catalyst in a sulfiding atmosphere replaces at least some of the polymer's functional group heteroatoms with sulfur, which is believed to help minimize or prevent the hydrogenation metals from clustering together or interacting with the support, which minimized clustering and/or interacting with the support in turn is believed to contribute to the observed enhanced catalyst activity. In addition, it is theorized that the polymer (after sulfidation) may suppress sintering of the hydrogenation metals, contributing to improved stability of the supported catalyst.

The catalyst compositions of this invention can be used in the hydrotreating, hydrodenitrogenation, and/or hydrodesulfurization of a wide range of hydrocarbon feeds. Examples of suitable feeds include middle distillates, kero, naphtha, vacuum gas oils, heavy gas oils, and the like.

Methods of the invention are methods for hydrotreating, hydrodenitrogenation, and/or hydrodesulfurization of a hydrocarbon feed, which methods comprise contacting a hydrocarbon feed and a catalyst of the invention. Hydrotreating of hydrocarbon feeds involves treating the feed with hydrogen in the presence of a catalyst composition of the invention at hydrotreating conditions.

Conventional hydrotreating process conditions, such as temperatures in the range of about 250° to about 450° C., reactor inlet hydrogen partial pressures in the range of about 5 to about 250 bar (about 5×10⁵ Pa to about 2.5×10⁷ Pa), space velocities in the range of about 0.1 to about 10 vol./vol·hr, and H₂/feed ratios in the range of about 50 to about 2000 NL/L, can be applied.

As shown in the Examples, polymer loadings up to at least 20 wt % relative to the other catalyst components were achieved. The amount of polymer present in the supported catalyst (polymer loading) is defined similarly to the way the amount of monomer relative to the other catalyst components is defined above. In other words, the amount of polymer in the catalysts of this invention is expressed as wt % relative to the total weight of the other components used to form the catalyst excluding any solvent. For example, if the total weight of the other components of the catalyst is 100 grams, 10 wt % of polymer is 10 grams. In this invention, the polymer loading is generally about 1.5 wt % or more, preferably in the range of about 1.5 wt % to about 35 wt %, although amounts outside these ranges are within the scope of the invention, relative to the total weight of the other components in the catalyst, which include the carrier, Group VI metal, and Group VIII metal, where the Group VI metal and Group VIII metal are expressed as their oxides; the weight of any solvent is excluded. The polymer loading is more preferably in the range of about 3 wt % to about 30 wt %, even more preferably in the range of about 5 wt % to about 25 wt %, still more preferably in the range of about 10 wt % to about 25 wt %, relative to the total weight of the other components of the catalyst, especially when the polymer is polyacrylic acid or polyacrylamide.

The following examples are presented for purposes of illustration, and are not intended to impose limitations on the scope of this invention.

In several Examples below, a carbon yield (C-yield) is reported. The carbon yield is defined as the % of carbon that was introduced into the sample via the monomer and was still present after drying of the materials.

In some instances, catalyst activities are reported as the relative weight activity (RWA). The relative weight activity for both hydrodesulfurization (HDS) and hydrodenitrogenation (HDN) are reported relative to a comparative run, where the catalytic activity of the comparative run is set at an arbitrary value (e.g., 100), and the RWA of the catalyst being tested is reported as a multiple of the value for the comparative catalyst run.

### Example 1

A stock supply of peroxomolybdocobaltate (i.e., containing cobalt and molybdenum but no phosphorus) was prepared by first mixing together MoO₃ (168.2 g), H₂O₂ (aq., 30%, 648 g), and water (581.5 g), a 1:5 to 6 ratio of Mo:H₂O₂, and heating to 70° C. An exothermic reaction occurred around this temperature, probably caused by formation of peroxomolybdates. After the exotherm settled, the mixture was allowed to cool to 50 to 60° C. Cobalt carbonate (CoCO₃, 74.4 g, equivalent to 43.5 g CoO), was then added, and the mixture was stirred for at least an hour. Evaporation of water to form a more concentrated solution caused formation of a non-soluble deposit, indicating that the solution was not concentratable by simple evaporation, so the solution was concentrated by spray-drying to obtain a solid. No monomer or initiator was present in this stock supply of peroxomolybdocobaltate. The desired concentration of cobalt and molybdenum for impregnation was prepared by dissolving the spray-dried solid in water.

### Example 2

Several samples were prepared from alumina and acrylamide, with different polymerization initiators and/or different amounts of the polymerization initiator. Acrylamide was 20 wt % relative to the weight of the combined monomer and carrier. After polymerization, the samples were dried at 80° C. The samples were analyzed by evolved gas analysis (EGA) at 600° C. under helium. Some of the compounds generated by the heating were acrylonitrile and acrylamide, which are known to be toxic. The polymer yield, similar to the carbon yield, was calculated as the amount of carbon remaining after EGA treatment divided by the amount of carbon in the dried product, and the polymer yield is reported in Table 1 below.

TABLE 1

| Run | Initiator | Initiator amount | | Polymer yield |
|---|---|---|---|---|
| 1 | Potassium persulfate | 0.5 | wt % | 40% |
| 2 | Ammonium persulfate | 0.5 | wt % | 66% |
| 3 | Ammonium persulfate | 0.75 | wt % | 86% |
| 4 | Potassium persulfate | 0.75 | wt % | 81% |
| 5 | Potassium persulfate | 1 | wt % | 98% |
| 6 | Ammonium persulfate | 1 | wt % | 87% |
| 7 | H₂O₂ | 1 | wt % | 38% |
| 8 | H₂O₂ | 5 | wt % | 69% |
| 9 | H₂O₂ | 10 | wt % | 80% |

| | | | |
|---|---|---|---|
| 10 | Peroxomolybdocobaltate | — | 82% |

The effect of the carrier on the polymerization when hydrogen peroxide is the initiator is noted, and theorized to be a pH effect, though this is not certain.

### Example 3

Several samples were prepared from water and the stock supply of peroxomolybdocobaltate prepared in Example 4 in an amount to provide 5.4 wt % as CoO, and 26 wt % as MoO₃ in solution. Acrylamide (AAM), alumina, and in one run, potassium persulfate (PPS), were mixed with the metals-containing solution. After impregnation and aging, each mixture was heated at 80° C. and monitored for the presence of an exotherm. An exotherm indicates occurrence of the polymerization reaction. Results are summarized in Table 2. Runs 11C and 12C are comparative.

TABLE 2

| Run | AAM | PeroxoMoCo | PPS | Alumina | Exotherm |
|---|---|---|---|---|---|
| 11C | 1.49 g | 0 | 0 | 5 g | no |
| 12C | 1.49 g | 2.90 g | 0 | 0 | no |
| 13 | 1.49 g | 2.90 g | 0 | 5 g | yes |
| 14 | 1.49 g | 2.90 g | 15 mg | 5 g | yes |

The results in Table 2 show that peroxomolybdocobaltate alone will not cause polymerization; both the peroxomolybdocobaltate and alumina or an initiator need to be present for polymerization to occur.

For a one step impregnation procedure, a solution with the required concentrations of molybdenum and cobalt was prepared from either a molybdenum compound and a cobalt compound, or from a peroxomolybdocobaltate compound. The monomer was then added at room temperature, followed by the initiator (when used). Then, the volume of the impregnation solution containing metals and monomer, and when used, phosphorus and/or initiator, was adjusted to 100% of the support pore volume by diluting with deionized water. Organic additives may be added at this point if desired. The temperature of the solution was kept below 50° C. during the preparation of the solution for the one step impregnation procedure to prevent polymerization in the solution before the impregnation has completed. The final solution should be a clear liquid. The final solution was then introduced onto the alumina extrudates at 90 to 105% saturation of its pores. The catalyst was allowed to age for at least 60 minutes below 50° C. to homogeneously distribute the solution throughout the alumina extrudates without inducing polymerization. After aging, polymerization was induced by heating the catalysts at 70 to 90° C. for at least 30 minutes. The polymerization was monitored by measuring the exotherm released during the polymerization. Once polymerization completed, the catalysts were dried at temperatures between 5° and 150° C. to remove excess water.

For a two-step impregnation procedure, a solution with the required concentrations of molybdenum and cobalt was prepared as described for the one step procedure, except that the monomer and initiator (when used) were not present in the solution. This solution was combined with the alumina extrudates and dried as described above. In the second impregnation step, a solution containing the monomer and, when used, the initiator was prepared in deionized water. The monomer-containing solution was introduced onto the metals-impregnated alumina extrudates at 90 to 105% saturation of its pores. The catalyst was allowed to age for at least 60 minutes at 40° C., and then was polymerized by heating the catalysts at 70 to 90° C. for at least 30 minutes. The polymerization was monitored by measuring the exotherm released during the polymerization. Once polymerization was completed, the catalysts were dried at temperatures between 5° and 150° C. to remove excess water.

In some of the following Examples, diethylene glycol (DEG) was used in comparative solutions because DEG is considered to be a state of the art additive. See in this connection U.S. Pat. Nos. 6,753,291 and 6,923,904.

### Example 4

### Preparation of Polymer-Modified Catalysts Containing Co and Mo

The catalysts in all of the runs in this Example were prepared using the one-step impregnation method described above and a portion of the stock supply of peroxomolybdocobaltate prepared in Example 1. Some samples were made with acrylamide (AAM) and portions of the stock solution (Runs 15, 16, and 17). To prepare the samples, a quantity of the stock solution was weighed into a round bottom flask. Some of the samples did not contain acrylamide. At the appropriate point in the impregnation procedure, acrylamide (and sometimes potassium persulfate, PPS) was added. Extrudates of gamma-alumina having a surface area of 271 m²/g were used as the carrier. The amounts of the reagents and some of the catalyst properties are listed in Table 3 below. In Table 3, the amounts of Co, Mo, and alumina are reported relative to the total weight of the carrier and hydrogenation metals; the amounts of monomer, initiator, and organic additive are relative to the total (dry) weight of the catalyst, where the total weight of the catalyst includes the MoO₃, CoO, monomer, initiator, but not the organic additive. The organic additive was diethylene glycol (DEG). Runs 15C and 16C are comparative.

In a comparative run (19C), a solution of acrylamide and alumina was made and heated to 80° C.; no exotherm was observed, and was interpreted to indicate that no polymerization had occurred. In another comparative run (18C), a solution of molybdenum, cobalt, and acrylamide was made and heated to 80° C.; no exotherm was observed, and was interpreted to indicate that no polymerization had occurred. In contrast, exotherms were observed for Run 16 (15° increase) and Run 17 (10° increase).

TABLE 3

| | Catalyst content | | | Reagent amounts | | | |
|---|---|---|---|---|---|---|---|
| | MoO₃ | CoO | Al₂O₃ | AAM | PPS | DEG | Polymer |
| Run | (wt %) | (wt %) | (wt %) | (wt %) | (wt %) | (wt %) | formed? |
| 15 | 24.0 | 6.2 | 69.8 | 20 | 0.2 | — | yes |
| 16 | 27.5 | 7.2 | 65.3 | 20 | 0.2 | — | yes |
| 17 | 27.5 | 7.2 | 65.3 | 20 | — | — | yes |
| 18C | yes | yes | — | yes | — | — | no |
| 19C | — | — | yes | yes | — | — | no |
| 15C | 24.0 | 6.2 | 69.8 | — | — | 20 | — |
| 16C | 27.5 | 7.2 | 65.3 | — | — | 20 | — |

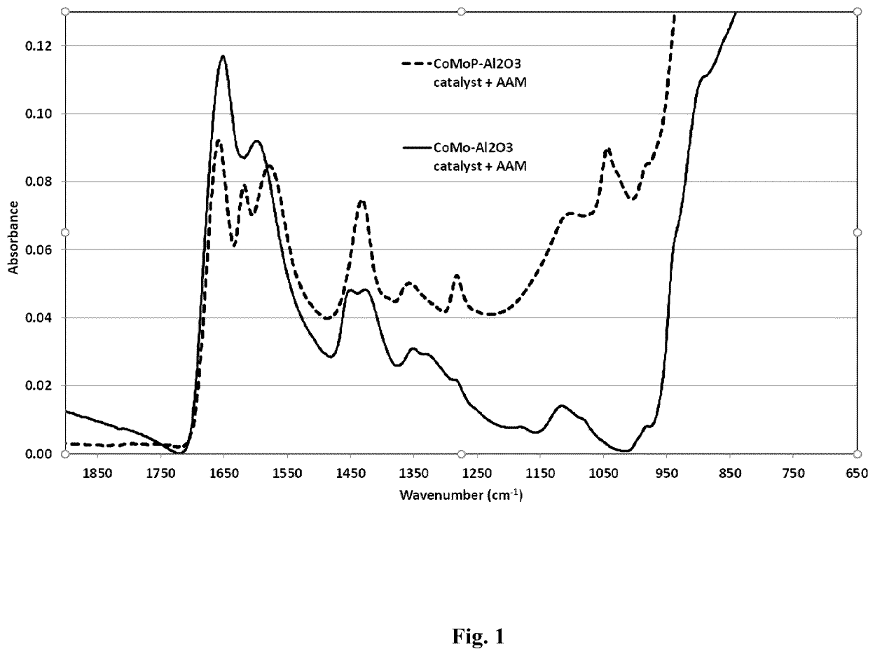

FIG. 1 shows FT-IR spectra for an inventive catalyst similar to that in Run 17 (solid line; no initiator) and a comparative run similar to Run 17 but containing phosphorus (dashed line). This comparative sample did not show signs of polymerization, such as an exotherm during preparation. In addition, some features of acrylamide can be recognized in the FT-IR spectrum of the comparative sample, such as the acrylamide C—N stretch at 1430 cm⁻¹ and —CH₂— rocking at 1053 cm⁻¹ (dashed line), based on a comparison to literature (Journal of the Korean Physical Society, 1998, 32, 505-512). For the inventive catalyst similar to that in Run 17, the FT-IR spectrum (solid line) shows the disappearance of characteristic acrylamide signals such as the C—C stretch at 1612 cm⁻¹, and appearance of polyacrylamide signals, such as the —CH₂— deformation at 1465 cm⁻¹ and C—N stretch at 1420 cm⁻¹, suggesting successful polymerization. The heterogeneity of these catalysts prevents thorough characterization.

### Example 5

### Activity Testing of Catalysts Containing Co and Mo

Catalysts prepared as described in Example 3 were ground; powder fractions of 125 to 310 μm were isolated by sieving. The 125 to 310 μm fractions were evaluated for their performance in hydrodesulfurization and hydrodenitrogenation. The catalysts were sulfided by contacting them with dimethyl disulfide (2.5 wt % S) spiked straight run gas oil (SRGO) just prior to running the test; the pre-sulfiding conditions are set forth in the Table 4A. Catalyst testing was performed using a high-throughput test unit (HTU). An SRGO feed having a density of 0.849 g/mL at 15° C., a sulfur content of 13713 ppm, and a nitrogen content of 121 ppm was used for testing. The three different conditions that were used for testing are set forth in Table 4B.

TABLE 4A

| Presulfiding | | P, | LHSV,* | H₂/oil, | Rxn T, | Rxn T, | Rxn T, | |
|---|---|---|---|---|---|---|---|---|
| condition | Feed | bar | 1/hr | NL/L | start | end | ramp | Time |
| A | 2099 | 45 | 3 | 300 | 50° C. | 65° C. | 10° C./hr | 24 hr |
| B | 2099 | 45 | 3 | 300 | 65° C. | 250° C. | 34.3° C./hr | 7.6 hr |
| C | 2099 | 45 | 3 | 300 | 250° C. | 320° C. | 20° C./hr | 8.5 hr |

* LHSV is the liquid hourly space velocity.

TABLE 4B

| | | WHSV, ¹ | H₂/oil, | | TOS,² | | |
|---|---|---|---|---|---|---|---|
| Test condition | P, bar | 1/hr | NL/L | T | days | nHDS³ | nHDN³ |
| 1 | 45 | 5.25 | 200 | 315° C. | 3.0 | 1.3 | 1.0 |
| 2 | 45 | 4.76 | 200 | 350° C. | 6.7 | 1.2 | 1.0 |
| 3 | 30 | 1.73 | 200 | 350° C. | 9.7 | 1.1 | 1.0 |

¹ WHSV is the weight hourly space velocity.
²TOS is time on stream.
³Reaction orders for hydrodesulfurization (HDS) and hydrodenitrogenation (HDN).

Several periodic drains (samples) were taken during each test condition. Table 5 sets forth the average S and N numbers at each test condition, which are averages of several samples, as well as the relative weight activity (RWA) of the different catalysts. The relative weight activity for both hydrodesulfurization (HDS) and hydrodenitrogenation (HDN) are reported relative to a comparative run, where the catalytic activity of the comparative run is set at an arbitrary value (e.g., 100), and the RWA of the catalyst being tested is reported as a multiple of the value for the comparative catalyst run. In these runs, the RWAs from the runs using polymer-containing catalysts are given relative to the RWAs from runs using DEG-containing catalysts, which were normalized to 100%. Significant catalytic activity increases can be achieved for catalysts containing polyacrylamide in comparison to the catalysts containing diethylene glycol where the catalyst composition is otherwise the same (see Table 5). The HDS activity increase on a weight basis is about 10 wt % to about 20 wt %, depending on the test conditions and catalyst composition. Runs 15C and 16C are comparative; run 15C is comparative for run 15, and run 16C is comparative for runs 16 and 17.

TABLE 5

| | | Catalyst | | | | |
|---|---|---|---|---|---|---|
| | | 15 | 15C | 16 | 16C | 17 |
| | | Catalyst features | | | | |
| | | | | | | 20 wt % |
| | | 20 wt % | 20 wt % | 20 wt % | 20 wt % | AAM |
| | | AAM | DEG | AAM | DEG | (no initiator) |
| | | Catalyst loaded | | | | |
| | | 0.67 g | 0.69 g | 0.73 g | 0.72 g | 0.73 g |
| Cond. 1 | ppm S | 2274 | 2538 | 2218 | 2664 | 2195 |
| | RWA HDS | 111% | 100% | 113% | 100% | 115% |
| | ppm N | 83 | 86 | 78 | 88 | 77 |
| | RWA HDN | 115% | 100% | 135% | 100% | 137% |
| Cond. 2 | ppm S | 269 | 355 | 184 | 338 | 177 |
| | RWA HDS | 112% | 100% | 124% | 100% | 127% |
| | ppm N | 34 | 45 | 18 | 39 | 17 |
| | RWA HDN | 130% | 100% | 171% | 100% | 174% |
| Cond. 3 | ppm S | 58 | 100 | 33 | 86 | 32 |
| | RWA HDS | 118% | 100% | 125% | 100% | 125% |
| | ppm N | 26 | 36 | 15 | 30 | 15 |
| | RWA HDN | 131% | 100% | 149% | 100% | 149% |

### Example 6

### Preparation of Polymer-Modified Catalysts Containing Co and Mo

The procedure of Example 4 was followed to prepare catalyst samples containing Co and Mo with acrylamide (AAM), using a portion of the stock supply of peroxomolybdocobaltate prepared in Example 4 and an extruded alumina carrier. Some of the alumina carriers contained boron, silicon, or titanium; the boron was introduced by co-extrusion with the alumina; titanium was introduced by impregnation, and silicon was introduced by co-precipitation. Procedures for co-extrusion are described for example in International Publication No. WO 2010/121807. The catalysts in all of the runs in this Example were prepared using the one-step impregnation method described above. The amounts of the reagents and some of the catalyst properties are listed in Table 6. In Table 6, the amounts of Co, Mo, and alumina are reported relative to the total weight of the carrier, hydrogenation metals, and phosphorus; the amounts of monomer, initiator, and organic additive are relative to the total (dry) weight of the alumina, MoO₃, and CoO.

TABLE 6

| | Catalyst content | | Al₂O₃ | Reagent amounts | | |
|---|---|---|---|---|---|---|
| | MoO₃ | Co:Mo | surface area, | Dopant in Al₂O₃ | AAM* | PPS* |
| Run | (wt %) | (molar) | m²/g | (wt %) | (wt %) | (wt %) |
| A | 24.1 | 0.5 | 348 | — | 17.9 | 0.18 |
| B | 24.4 | 0.5 | 271 | — | 18.1 | 0.18 |
| C | 24.0 | 0.5 | 186 | — | 17.8 | 0.18 |
| D | 25.1 | 0.5 | 260 | SiO₂ (8.0) | 18.6 | 0.19 |
| E | 26.0 | 0.5 | 252 | B₂O₃ (2.7) | 19.3 | 0.19 |
| F | 22.7 | 0.5 | 268 | TiO₂ (10) | 16.8 | 0.17 |

*AAM is acrylamide; PPS is potassium persulfate.

Samples from the runs listed in Table 6 were subjected to scanning electron microscopy energy-dispersive x-ray (SEM-EDX) linescan analysis. Each sample was dried at 150° C. for 24 hours under vacuum (˜0.05 mbar), and then embedded in an epoxy resin (EpoFix, Struers Inc.) at atmospheric pressure. In order to avoid resin penetration into the extrudates as much as possible (<5 μm), the resin was pre-cured for approximately 70 minutes prior to the embedding procedure. The embedded samples were ground and polished under nitrogen to minimize exposure of the samples to atmosphere, and then coated with gold layer to a thickness of about 2 nm. The linescan measurements were performed on a scanning electron microscope (Zeiss EVO MA 15 with Noran system 7; source: LaB₆; beam current: 4.2 nA).

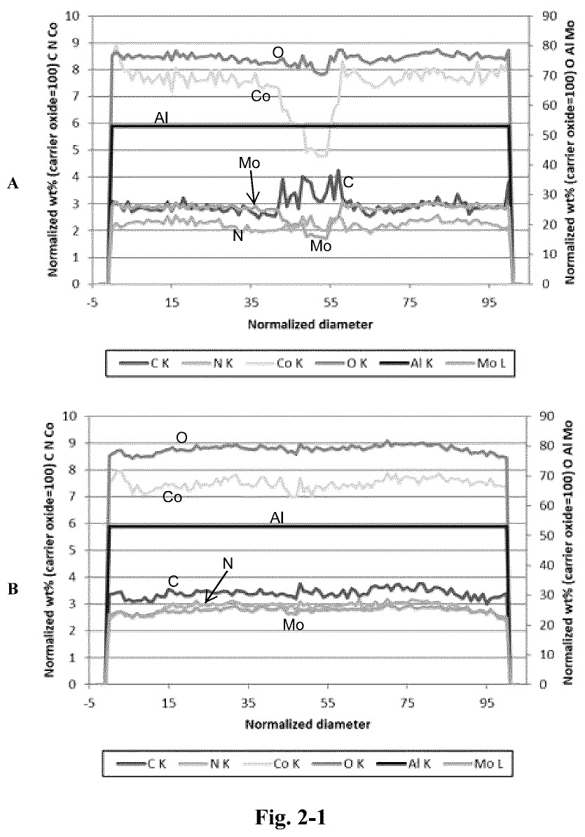

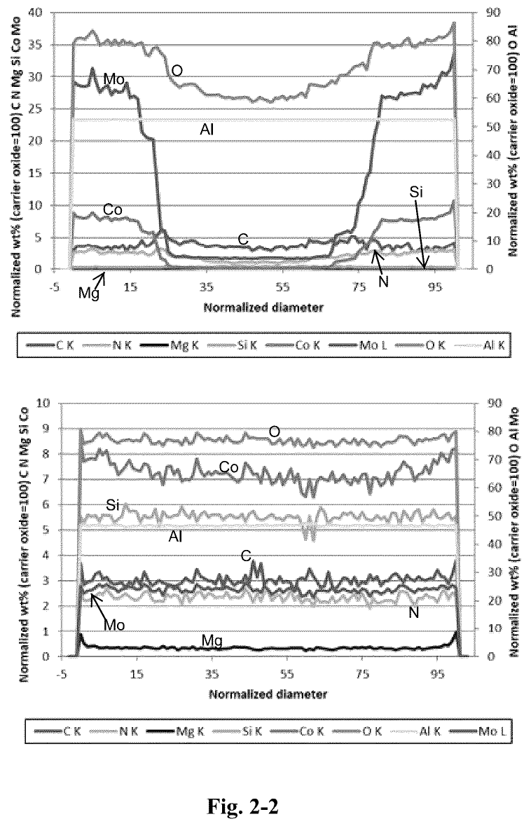

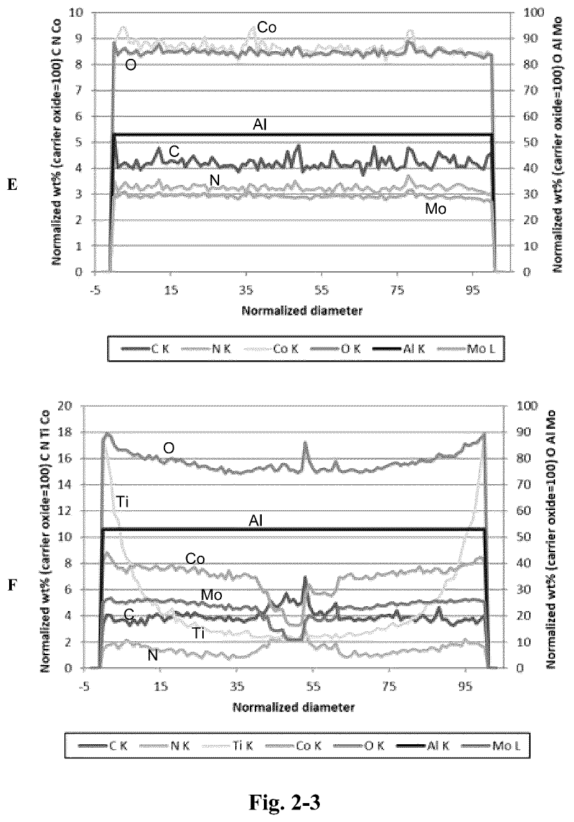

Results are shown in FIGS. 2-1 to 2-3 as grams of element per 100 grams carrier (here, alumina). Over the cross section of an extrudate (carrier), the weight of pure carrier per unit of volume does not change regardless the weight of impregnated elements, so the grams of elements indicate whether the element is present throughout the carrier or just on its surface. Note that the scale for the elements on the left of the linescan graphs is much smaller than the scale for the elements on the right of the linescan graph. The carbon and nitrogen distributions in the graphs are relatively flat, which indicates that the polymer is formed throughout the whole carrier in Runs A-F.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A supported catalyst comprising a carrier, at least one Group VI metal, at least one Group VIII metal, and a polymer, where the molar ratio of the Group VI metal to the Group VIII metal is about 1:1 to about 5:1, and where the polymer has a carbon backbone and comprises functional groups having at least one heteroatom.

2. A supported catalyst as in claim 1 wherein said carrier is carbon, carbon in combination with one or more inorganic oxides, boria, titania, silica, alumina, silica-alumina, alumina with silica-alumina dispersed therein, alumina-coated silica, silica-coated alumina, alumina containing boron, alumina containing silicon, alumina containing titanium, or a combination of any two or more of these.

3. A supported catalyst as in claim 1 wherein the functional groups of the polymer are carboxylic acid groups or amido groups.

4. A supported catalyst as in claim 1 wherein the polymer is polymaleic acid, polyfumaric acid, polyacrylic acid, poly(2-carboxyethyl) acrylate, poly(N-hydroxyethyl) acrylamide, polyacrylamide, or a co-polymer of any two or more of the foregoing.

5. (canceled)

6. A supported catalyst as in any of claim 1 wherein said Group VI metal is molybdenum and/or tungsten, and/or wherein said Group VIII metal is nickel and/or cobalt.

7. A supported catalyst as in any of claim 1 which has a polymer loading of about 1.5 wt % or more, relative to the total weight of the carrier, Group VI metal, and Group VIII metal, where the Group VI metal and Group VIII metal are expressed as their oxides.

8. A supported catalyst as in any of claim 1 which has an average particle size of about 0.5 mm to about 5 mm.

9. (canceled)

10. (canceled)

11. (canceled)

12. A process for forming a supported catalyst, which process comprises
I) bringing together a carrier, one or more monomer species, a solvent, and a peroxomolybdocobaltate compound or at least one Group VI metal compound and at least one Group VIII metal compound, in any of the following combinations:
a) a carrier, one or more monomer species, and a solvent,
b) a carrier, one or more monomer species, and a peroxomolybdocobaltate compound or at least one Group VI metal compound and at least one Group VIII metal compound, or
c) a carrier and an impregnation solution, forming an impregnated carrier, followed by mixing the impregnated carrier with one or more monomer species, to form a monomer-containing mixture, where said one or more monomer species is soluble in the solvent and has carbon-carbon unsaturation and at least one functional group comprising at least one heteroatom; and
II) initiating polymerization of at least a portion of said one or more monomer species in the monomer-containing mixture to form a polymerized product;
III) when the monomer-containing mixture in I) is formed as in a), either
a) contacting an impregnation solution and the monomer-containing mixture during the polymerization in II), or
b) contacting the polymerized product and an impregnation solution; to form a supported catalyst, where the molar ratio of the Group VI metal to the Group VIII metal is about 1:1 to about 5:1, and where said impregnation solution comprises a solvent, at least one Group VI metal, and at least one Group VIII metal.

13. A process as in claim 12 wherein a single impregnation step is carried out
a) in I) when bringing together a carrier, one or more monomer species, and a peroxomolybdocobaltate compound or at least one Group VI metal compound and at least one Group VIII metal compound;
b) in I), when bringing together a carrier and an impregnation solution; or
c) in III).

14. A process as in claim 12 further comprising removing excess solvent from the supported catalyst.

15. A process as in claim 14 wherein the polymerizing is carried out during the removing of excess solvent.

16. A process as in claim 12 further comprising sulfiding the supported catalyst.

17. A process as in claim 12 wherein the monomer-containing mixture in I) is formed as in b).

18. A process as in claim 12 wherein the heteroatom of the functional group of the monomer species comprises nitrogen, oxygen, phosphorus, and/or sulfur.

19. A process as in claim 12 wherein the functional group of the monomer species is a carboxylic acid group, an ester group, a carboxyl group, or an amido group.

20. A process as in claim 12 wherein the monomer species is maleic acid, fumaric acid, acrylic acid, 2-carboxyethyl acrylate, acrylamide, or N-hydroxyethyl acrylamide.

21. (canceled)

22. (canceled)

23. (canceled)

24. A process as in claim 12 wherein a chemical substance is employed as an initiator, and wherein the chemical substance comprises a persulfate salt.

25. A process as in claim 17 wherein said solvent is water.

26. A process as in claim 17 wherein said Group VI metal compound is an oxide or an oxo-acid.

27. A process as in claim 17 wherein said Group VIII metal compound is a carbonate, hydroxide, or hydroxy-carbonate.

28. (canceled)

29. (canceled)

30. A process as in claim 12 wherein the carrier has been calcined and/or extruded prior to step I) of the process.

31. A process as in claim 12 wherein the carrier has an average particle size of about 0.5 mm to about 5 mm, and wherein the supported catalyst has an average particle size of about 0.5 mm to about 5 mm.

32. (canceled)

33. (canceled)

34. (canceled)

35. (canceled)

36. (canceled)

37. (canceled)

38. (canceled)

39. A peroxomolybdocobaltate compound comprising cobalt and molybdenum in a cobalt:molybdenum ratio of about 0.5:2 to about 1.5:2.

40. (canceled)

41. A process for forming a peroxomolybdocobaltate compound, which process comprises
a) bringing together, in a polar solvent, at least one molybdenum compound and at least one oxidant to form a molybdenum-containing mixture;
b) combining the molybdenum-containing mixture and at least one cobalt compound to form a molybdenum-cobalt mixture in a cobalt:molybdenum ratio of about 0.5:2 to about 1.5:2; and
c) spray-drying the molybdenum-cobalt mixture to obtain the peroxomolybdocobaltate compound.

42. A process as in claim 41 wherein the oxidant is hydrogen peroxide.

43. A process as in claim 42 wherein the molar ratio of molybdenum to hydrogen peroxide is in the range of about 1:4 to about 1:7.

44. (canceled)

45. (canceled)
